(19) United States
(12) Patent Application Publication
(10) Pub. No.: US 2024/0054422 A1
(43) Pub. Date: Feb. 15, 2024

(54) MANAGEMENT DEVICE, MANAGEMENT METHOD, AND MANAGEMENT SYSTEM

(71) Applicant: TOYOTA JIDOSHA KABUSHIKI KAISHA, Toyota-shi (JP)

(72) Inventors: Atsushi KOMADA, Nagakute-shi (JP); Mitsuru OGASAWARA, Gamagori-shi (JP); Masahiko ISHII, Okazaki-shi (JP); Hidetaka ASANO, Nissin-shi (JP); Tomokazu ISHII, Okazaki-shi (JP); Koji HETSUGI, Toyota-shi (JP); Kosuke YONEKAWA, Nisshin-shi (JP); Yoshikazu JIKUHARA, Miyoshi-shi (JP)

(73) Assignee: TOYOTA JIDOSHA KABUSHIKI KAISHA, Toyota-shi (JP)

(21) Appl. No.: 18/216,228

(22) Filed: Jun. 29, 2023

(30) Foreign Application Priority Data
Aug. 15, 2022 (JP) 2022-129355

(51) Int. Cl. G06Q 10/0635; G06Q 50/04

(52) U.S. Cl. CPC G06Q 10/0635; G06Q 50/04

(57) ABSTRACT

A management device includes a communication unit that communicates with a company and a processor that calculates an amount of carbon dioxide emitted by manufacturing a product using a predetermined calculation method. The communication unit notifies the company of information including the amount of carbon dioxide, and the predetermined calculation method.

### CROSS-REFERENCE TO RELATED APPLICATION

This application claims priority to Japanese Patent Application No. 2022-129355 filed on Aug. 15, 2022, incorporated herein by reference in its entirety.

### BACKGROUND

### 1. Technical Field

The present disclosure relates to a management device, a management method, and a management system.

### 2. Description of Related Art

With growing awareness of environmental issues, there is growing interest in an emission amount of carbon dioxide emitted for manufacturing products that are distributed on the market. An upstream company in a supply chain may be requested by a downstream company to which products are supplied to disclose the emission amount of carbon dioxide emitted for manufacturing the products. The upstream company calculates the emission amount of carbon dioxide emitted for manufacturing the products and discloses the emission amount of carbon dioxide to the downstream company. For example, Japanese Unexamined Patent Application Publication No. 2016-126372 (JP 2016-126372 A) discloses a method of calculating an emission amount of carbon dioxide in a transportation process of products (including materials and components).

### SUMMARY

Here, legal regulations may require a downstream company to disclose a calculation method for an emission amount of carbon dioxide. In a case where such legal regulations are enacted, it is desirable for the downstream company to recognize a calculation method for an emission amount of carbon dioxide of products supplied by an upstream company.

The present disclosure provides a management device, a management method, and a management system that enable a downstream company to recognize a calculation method for an emission amount of carbon dioxide of a product supplied by an upstream company.

A first aspect of the present disclosure relates to a management device that manages a product to be delivered from a first company to a second company provided downstream of the first company. The management device is provided in the first company. The management device includes a communication unit and a calculation unit. The communication unit is configured to communicate with the second company. The calculation unit is configured to calculate a first amount of carbon dioxide emitted by manufacturing the product using a first calculation method. The communication unit is configured to notify the second company of information including the first amount of carbon dioxide, and the first calculation method.

In the management device according to the first aspect of the present disclosure, as described above, the communication unit is configured to notify the second company of the information including the first amount of carbon dioxide, and the first calculation method. With this, a downstream company (second company) can recognize a calculation method for an emission amount of carbon dioxide of a product supplied by an upstream company (first company).

In the management device according to the first aspect, the communication unit may be configured to notify the second company of the first calculation method together with the information including the first amount of carbon dioxide. With this configuration, the second company is notified of the first amount of carbon dioxide corresponding to the product, and the first calculation method, as a set. With this, the second company can easily perform management by linking the first amount of carbon dioxide and the first calculation method with each other.

In the management device according to the first aspect, a basic product constituting the product may be supplied to the first company from a third company provided upstream of the first company. The third company may calculate a second amount of carbon dioxide emitted by manufacturing the basic product using a second calculation method. The communication unit may be configured to notify the second company of the information including the first amount of carbon dioxide, and the first calculation method, and information including the second amount of carbon dioxide, and the second calculation method. With this configuration, the second company can recognize the second calculation method for calculating the second amount of carbon dioxide corresponding to the manufacturing of the basic product, in addition to the first calculation method.

In the management device according to the first aspect, the communication unit may be configured to notify the second company of the first calculation method together with the first amount of carbon dioxide and notify the second company of the second calculation method together with the second amount of carbon dioxide. With this configuration, the second company is also notified of the second amount of carbon dioxide corresponding to the basic product, and the second calculation method, as a set. With this, the second company can easily perform management by linking the first amount of carbon dioxide and the first calculation method with each other, and can easily perform management by linking the second amount of carbon dioxide and the second calculation method with each other.

In the management device according to the first aspect, the first calculation method may include information indicating that the first amount of carbon dioxide is calculated based on at least one of an amount of electricity and an amount of energy used in manufacturing the product at the first company. With this configuration, the second company can easily grasp the method by which the first amount of carbon dioxide is calculated.

A second aspect of the present disclosure relates to a management method of managing a product to be delivered from a first company to a second company provided downstream of the first company. The management method includes a first step and a second step. In the first step, a first amount of carbon dioxide emitted by manufacturing the product at the first company is calculated using a predetermined calculation method at the first company. In the second step, the second company is notified of, from the first company, information including the first amount of carbon dioxide, and the predetermined calculation method.

In the management method according to the second aspect of the present disclosure, as described above, the second company is notified of the first amount of carbon dioxide emitted by manufacturing the product at the first company and the predetermined calculation method for calculating the first amount of carbon dioxide. With this, it is possible to provide a management method of enabling a downstream company (second company) to recognize a calculation method for an emission amount of carbon dioxide of a product supplied by an upstream company (first company).

In the management method according to the second aspect, a third step of adding up a second amount of carbon dioxide emitted in manufacturing a basic product constituting the product and the first amount of carbon dioxide to obtain an adding amount and dividing the adding amount by the number of the product to calculate an emission amount of carbon dioxide per product may further be provided.

In the management method according to the second aspect, a fourth step of managing the emission amount of carbon dioxide per product and the predetermined calculation method in association with each other may further be provided.

A third aspect of the present disclosure relates to a management system. The management system includes a first management device and a second management device. The first management device is provided in a first company. The second management device is provided in a second company to which a product is delivered from the first company. The second company is provided downstream of the first company. The first management device is configured to calculate an amount of carbon dioxide emitted by manufacturing the product using a predetermined calculation method and notify the second management device of information including the amount of carbon dioxide, and the predetermined calculation method.

In the management system according to the third aspect of the present disclosure, as described above, the second management device of the second company is notified of the amount of carbon dioxide emitted by manufacturing the product at the first company and the predetermined calculation method for calculating the amount of carbon dioxide. With this, it is possible to provide a management system that enables a downstream company (second company) to recognize a calculation method for an emission amount of carbon dioxide of a product supplied by an upstream company (first company).

According to the present disclosure, the downstream company can recognize the calculation method for the emission amount of carbon dioxide of the product supplied by the upstream company.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a management system according to one embodiment;

FIG. 2 is a diagram showing a packing box packed with a product according to one embodiment;

FIG. 3 is a sequence diagram of the management system according to one embodiment; and

FIG. 4 is a diagram showing a management table managed in a downstream company according to one embodiment.

### DETAILED DESCRIPTION OF EMBODIMENTS

Hereinafter, an embodiment of the present disclosure will be described in detail with reference to the drawings. In the drawings, the same or corresponding parts are denoted by the same reference numerals, and the description thereof will not be repeated.

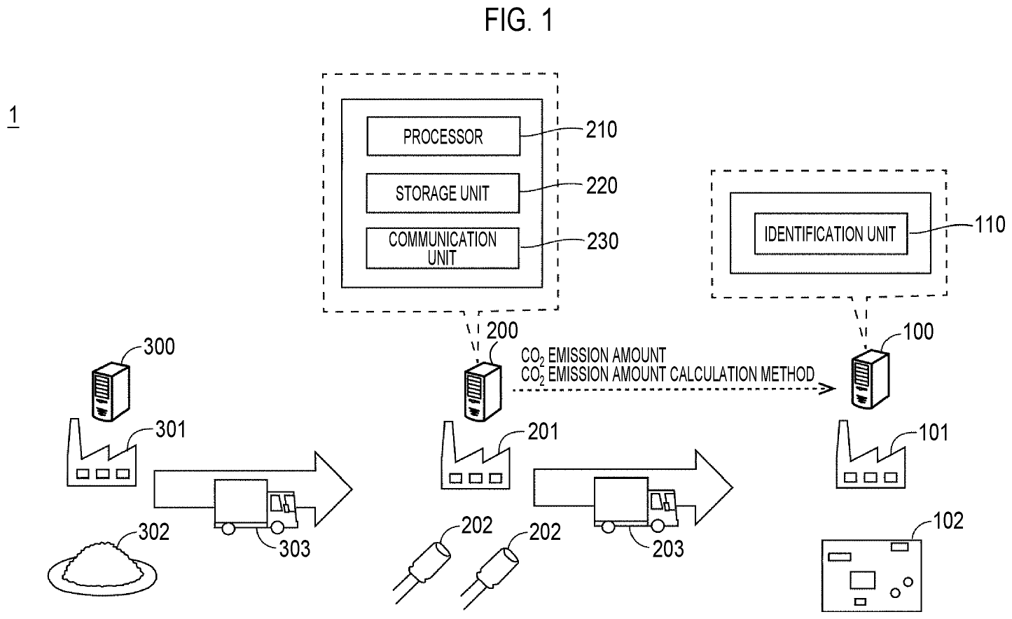

FIG. 1 is a diagram showing a configuration of a management system 1 according to the present embodiment. The management system 1 includes a management device 100 provided in a company 101, a management device 200 provided in a company 201, and a management device 300 provided in a company 301. The company 101 and the company 201 are examples of a “second company” and a “first company” of the present disclosure, respectively. The company 301 is an example of a “third company” of the present disclosure. The management device 100 is an example of a “second management device” of the present disclosure. The management device 200 is an example of a “management device” and a “first management device” of the present disclosure.

The company 101 is provided downstream of the company 201. Specifically, a product 202 is delivered from the company 201 to the company 101. In addition, the company 201 is provided downstream of the company 301. Specifically, a product 302 on which the product 202 is based is delivered from the company 301 to the company 201. The product on which the product 202 is based also includes a component that is combined with other components to constitute the product 202. In addition, a new product 102 manufactured by the company 101 using the product 202 may be delivered to a company provided downstream of the company 101. Further, each of the management device 100 and the management device 200 manages the product 202. The product 302 is an example of a “basic product” of the present disclosure.

In addition, the product 202 is manufactured by the company 201 and then is transported to the company 101 by a transport vehicle 203. Further, the product 302 is manufactured by the company 301 and then is transported to the company 201 by a transport vehicle 303.

The management device 200 includes a processor 210, a storage unit 220, and a communication unit 230. The processor 210 controls the communication unit 230. The processor 210 is an example of a “calculation unit” of the present disclosure.

The processor 210 calculates an amount of carbon dioxide emitted by manufacturing the product 202 using a predetermined calculation method. The predetermined calculation method is a method of calculating the emission amount of carbon dioxide using a predetermined calculation expression based on an amount of electricity used to manufacture the product 202 and an emission coefficient of carbon dioxide. The amount of carbon dioxide and the predetermined calculation method are examples of a “first amount of carbon dioxide” and a “first calculation method” of the present disclosure, respectively.

The storage unit 220 stores a program to be executed by the processor 210 as well as information (for example, maps, mathematical expressions, and various parameters) used in the program.

The communication unit 230 communicates with each of the company 101 (management device 100) and the company 301 (management device 300). The communication unit 230 includes various communication I/Fs.

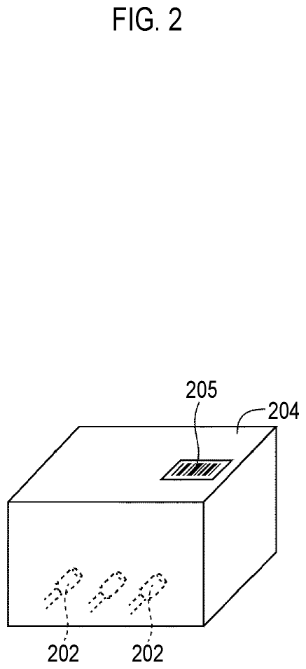

Here, a packing box 204 (see FIG. 2) packed with a plurality of products 202 is transported from the company 201 to the company 101. A barcode 205 (see FIG. 2) is attached to the packing box 204.

An identification unit 110 of the management device 100 can read (scan) the barcode 205. That is, the identification unit 110 includes a barcode reader. The identification unit 110 acquires identification information of the product 202 by reading the barcode 205.

The identification information of the product 202 includes a delivery number, delivery date and time, information on a supplier company (in this case, the company 201), information on the number of products 202 in the packing box 204, and the like.

Management Method of Product

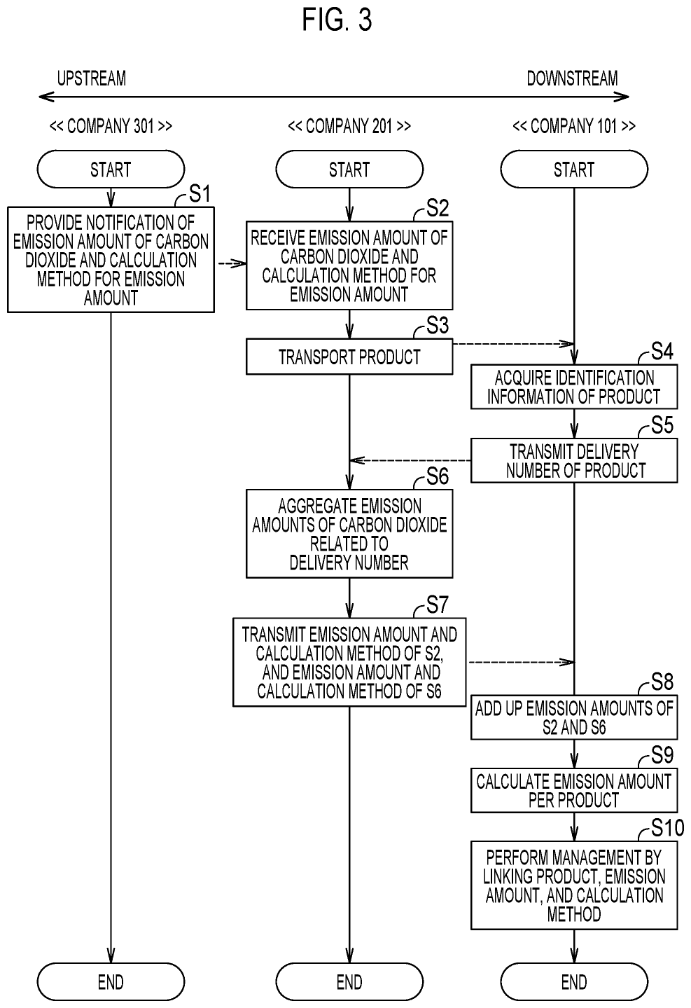

Next, a management method of the product 202 through the management system 1 will be described with reference to the sequence diagram of FIG. 3. A management method of the emission amount of carbon dioxide of the product 202 will be described.

First, in step S1, the company 301 (management device 300) transmits, to the company 201 (communication unit 230), information on an emission amount of carbon dioxide emitted by manufacturing the product 302 on a manufacturing line of the company 301. In addition, the management device 300 notifies the communication unit 230 of a calculation method of calculating the emission amount of carbon dioxide. Specifically, the management device 300 notifies the company 201 of the calculation method together with the information on the emission amount of carbon dioxide. The emission amount of carbon dioxide and the calculation method are examples of a “second amount of carbon dioxide” and a “second calculation method” of the present disclosure, respectively.

Further, the calculation method includes, for example, information indicating that the emission amount of carbon dioxide is calculated based on an amount of electricity used to manufacture the product 302. In addition, the calculation method includes information on an emission coefficient of carbon dioxide used in calculating the emission amount. Further, the calculation method may include information on the amount of electricity used to manufacture the product 302. In addition, the calculation method may include information on a calculation expression for calculating the emission amount of carbon dioxide corresponding to the product 302.

In addition, in step S1, the company 301 (management device 300) may transmit, to the company 201, information on an amount of carbon dioxide emitted from the transport vehicle 303 when the product 302 is transported by the transport vehicle 303. The amount of carbon dioxide emitted in transporting the product 302 may be transmitted to the company 201 from a company that manages the transport vehicle 303.

In step S2, the company 201 (management device 200) receives the information on the emission amount of carbon dioxide and the information on the calculation method for the emission amount transmitted in step S1. In a case where a company upstream of the company 301 is further provided, the company 201 (management device 200) may also receive an amount of carbon dioxide emitted by the upstream company and information on a calculation method for the emission amount of carbon dioxide in the upstream company.

In step S3, the company 201 transports the products 202 to the company 101 using the transport vehicle 203. The products 202 are transported by being packed in the packing box 204 (see FIG. 2). In the present embodiment, it is assumed that solely the packing box 204 is transported by the transport vehicle 203.

In step S4, the management device 100 (identification unit 110) of the company 101 reads (scans) the barcode 205 attached to the packing box 204 transported in step S3. With this, the management device 100 acquires the identification information of the product 202.

In step S5, the management device 100 transmits the delivery number included in the identification information acquired in step S4 to the management device 200 (communication unit 230) of the company 201.

In step S6, the management device 200 (processor 210) of the company 201 aggregates (calculates) the emission amounts of carbon dioxide of the products 202 corresponding to the delivery number transmitted in step S5. Specifically, the management device 200 calculates the amount of carbon dioxide emitted by manufacturing the products 202 based on an electricity consumption amount of a manufacturing line of the product 202.

In step S7, the management device 200 (communication unit 230) of the company 201 notifies the management device 100 of the company 101 of information on the amount of carbon dioxide emitted by manufacturing the products 202 aggregated (calculated) in step S6. In addition, the management device 200 (communication unit 230) notifies the management device 100 of the company 101 of the calculation method for the emission amount of carbon dioxide used in step S6.

Specifically, the management device 200 (communication unit 230) notifies the management device 100 of the company 101 of the calculation method together with the information on the emission amount of carbon dioxide. Further, the calculation method includes information indicating that the emission amount of carbon dioxide is calculated based on the amount of electricity used to manufacture the products 202, and information on the emission coefficient of carbon dioxide used in the calculation. In addition, the calculation method may include information on the amount of electricity used to manufacture the products 202. Further, the calculation method may include information on a calculation expression for calculating the emission amount of carbon dioxide corresponding to the products 202.

Further, in step S7, the management device 200 (communication unit 230) notifies the management device 100 of the company 101 of the emission amount of carbon dioxide corresponding to the product 302 and the information on the calculation method for the emission amount of carbon dioxide. Specifically, the management device 200 (communication unit 230) notifies the management device 100 of the calculation method together with the information on the emission amount of carbon dioxide.

In step S8, the management device 100 of the company 101 adds up the emission amount of carbon dioxide corresponding to step S2 and the emission amount of carbon dioxide corresponding to step S6. With this, the total amount of carbon dioxide emitted for manufacturing the products 202 is calculated. A value obtained by multiplying the emission amount of carbon dioxide corresponding to step S2 by a predetermined coefficient, and the emission amount of carbon dioxide corresponding to step S6 may be added up. The predetermined coefficient may vary depending on the number (quantity) of products 302 used to manufacture the product 202.

In step S9, the management device 100 calculates an emission amount of carbon dioxide per product 202. Specifically, the management device 100 divides the total value of the emission amount of carbon dioxide calculated in step S8 by the number of products 202 included in the identification information acquired in step S4.

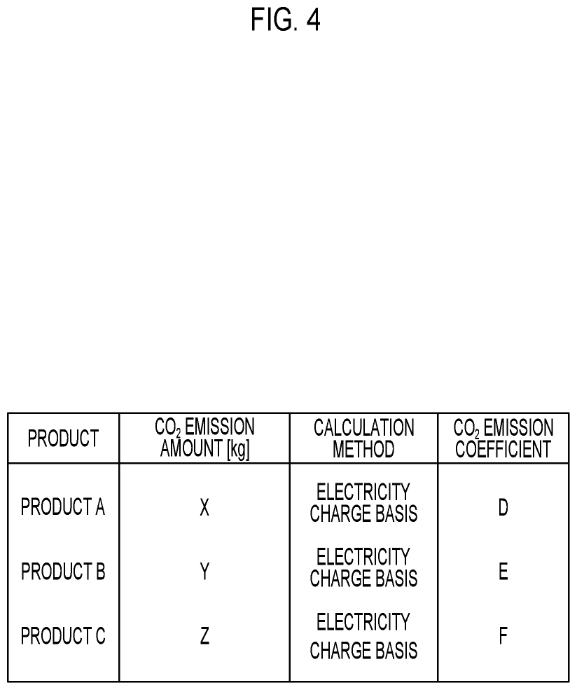

In step S10, the management device 100 performs management by linking (associating) the emission amount of carbon dioxide per product 202 calculated in step S9, the product 202, and the calculation method with each other. For example, the management device 100 stores a management table 121 (see FIG. 4) in which the product 202, the emission amount of carbon dioxide, the calculation method, and the emission coefficient of carbon dioxide are linked. FIG. 4 shows an example in which the emission amount of carbon dioxide is linked for each product (for each of A, B, and C). In FIG. 4, products A to C are named to distinguish the products 202, and emission coefficients of the carbon dioxide corresponding to the products A to C are denoted by D to F, respectively. The emission coefficients D to F may be the same value as each other. In the management table 121, the calculation method for the emission amount of carbon dioxide corresponding to the product 302 may also be managed by being linked to the product 202 and the like.

In addition, the company 101 (management device 100) links the emission amount of carbon dioxide to each of the delivered products (see FIG. 4), and manages the emission amount of carbon dioxide and the calculation method for each component. Then, an emission amount of carbon dioxide for each component used in the product 102 manufactured by the company 101 and an amount of carbon dioxide emitted in manufacturing the product 102 are added, thereby calculating an emission amount of carbon dioxide of the product 102.

As described above, in the present embodiment, the communication unit 230 notifies the company 101 of the amount of carbon dioxide emitted by the company 201 and the calculation method for calculating the amount of carbon dioxide. As a result, the company 101 that is the downstream company can perform management by linking the emission amount of carbon dioxide of the product 202 and the calculation method with each other.

In the embodiment, an example has been described in which the company 101 is notified of the calculation method together with the amount of carbon dioxide emitted by the company 201, but the present disclosure is not limited thereto. The company 101 may be separately notified of the amount of carbon dioxide and the calculation method.

In the embodiment, an example has been described in which the company 101 is notified of the calculation method together with the amount of carbon dioxide emitted by the company 301, but the present disclosure is not limited thereto. The company 101 may be separately notified of the amount of carbon dioxide and the calculation method.

In the embodiment, an example has been described in which the calculation method for the emission amount of carbon dioxide includes the information indicating that the calculation method is based on the amount of electricity used in manufacturing the product 202 (302), but the present disclosure is not limited thereto. For example, the calculation method may include information indicating that the calculation method is based on the amount of energy used in manufacturing the product 202 (302). Alternatively, the calculation method may include information indicating that the calculation method is based on both the amount of electricity and the amount of energy.

In the embodiment, an example has been described in which the barcode 205 is attached to the packing box 204, but the present disclosure is not limited thereto. For example, a barcode may be attached to each of the products 202. Alternatively, code information different from the barcode (for example, a two-dimensional barcode) may be used. Alternatively, the delivery number may be attached to the product 202, the packing box 204, or the like, and the delivery number may be transmitted to the company 201 based on the delivery number input by an operator into the management device 100.

In the embodiment, an example has been described in which the emission amount of carbon dioxide corresponding to the company 301 and the emission amount of carbon dioxide corresponding to the company 201 are added up in the management device 100 of the company 101, but the present disclosure is not limited thereto. For example, the management device 200 of the company 201 may perform the adding-up processing. In addition, the management device 200 may calculate the emission amount of carbon dioxide per product.

In the embodiment, an example has been described in which the emission amount of carbon dioxide corresponding to the company 301 and the emission amount of carbon dioxide corresponding to the company 201 are added up, but the present disclosure is not limited thereto. The emission amount of carbon dioxide corresponding to the company 301 need not be considered.

In the embodiment, an example has been described in which the company 101 (management device 100) acquires, from the company 201, the information on the amount of carbon dioxide emitted in manufacturing and transporting the product 302, but the present disclosure is not limited thereto. The company 101 (management device 100) may acquire, from the company 301, the information on the amount of carbon dioxide emitted in manufacturing and transporting the product 302.

In a case where a plurality of types of products is transported at the same time, an amount of carbon dioxide emitted for transporting the products may be calculated based on a weight of the products. For example, an amount of carbon dioxide emitted for transporting one product may be calculated based on a ratio of a weight per product to the total weight of products loaded on the transport vehicle and the total amount of carbon dioxide emitted during transportation.

Further, a history of the emission amount of carbon dioxide corresponding to the product may be managed between a plurality of companies by blockchain.

The embodiment disclosed this time should be considered illustrative and not restrictive in all respects. The scope of the present disclosure is indicated by the scope of claims rather than by the description of the above-described embodiment, and is intended to include all modifications within the scope and meaning equivalent to the scope of the claims.

What is claimed is:

1. A management device that manages a product to be delivered from a first company to a second company provided downstream of the first company, the management device being provided in the first company, the management device comprising:
a communication unit configured to communicate with the second company; and
a calculation unit configured to calculate a first amount of carbon dioxide emitted by manufacturing the product using a first calculation method,
wherein the communication unit is configured to notify the second company of information including the first amount of carbon dioxide, and the first calculation method.

2. The management device according to claim 1, wherein the communication unit is configured to notify the second company of the first calculation method together with the information including the first amount of carbon dioxide.

3. The management device according to claim 1, wherein:
a basic product constituting the product is supplied to the first company from a third company provided upstream of the first company;
the third company calculates a second amount of carbon dioxide emitted by manufacturing the basic product using a second calculation method; and
the communication unit is configured to notify the second company of the information including the first amount of carbon dioxide, and the first calculation method, and information including the second amount of carbon dioxide, and the second calculation method.

4. The management device according to claim 3, wherein the communication unit is configured to notify the second company of the first calculation method together with the first amount of carbon dioxide and notify the second company of the second calculation method together with the second amount of carbon dioxide.

5. The management device according to claim 1, wherein the first calculation method includes information indicating that the first amount of carbon dioxide is calculated based on at least one of an amount of electricity and an amount of energy used in manufacturing the product at the first company.

6. A management method of managing a product to be delivered from a first company to a second company provided downstream of the first company, the management method comprising:
a first step of calculating a first amount of carbon dioxide emitted by manufacturing the product at the first company using a predetermined calculation method at the first company; and
a second step of notifying, from the first company, the second company of information including the first amount of carbon dioxide, and the predetermined calculation method.

7. The management method according to claim 6, wherein a third step of adding up a second amount of carbon dioxide emitted in manufacturing a basic product constituting the product and the first amount of carbon dioxide to obtain an adding amount and dividing the adding amount by the number of the product to calculate an emission amount of carbon dioxide per product.

8. The management method according to claim 7, wherein a fourth step of managing the emission amount of carbon dioxide per product and the predetermined calculation method in association with each other.

9. A management system comprising:
a first management device provided in a first company; and
a second management device provided in a second company to which a product is delivered from the first company, the second company being provided downstream of the first company,
wherein the first management device is configured to
calculate an amount of carbon dioxide emitted by manufacturing the product using a predetermined calculation method, and
notify the second management device of information including the amount of carbon dioxide, and the predetermined calculation method.
